(19) United States
(12) Patent Application Publication
(10) Pub. No.: US 2016/0009279 A1
(43) Pub. Date: Jan. 14, 2016

(54) SYSTEM AND PROCESS FOR CONTROLLING A SAFE DISTANCE BETWEEN MOVING VEHICLES

(71) Applicant: Khalifa University of Science, Technology & Research (KUSTAR), Abu Dhabi (AE)

(72) Inventors: Shihab JIMAA, Sharjah (AE); Abdulrahman AL MULLA, Sharjah (AE); Abdulaziz Saeed AL ALI, Umm al-Quwain (AE); Ahmad Abdullah AL DAHMANI, Dubai (AE); Mohammed AL EMADI, Dubai (AE)

(21) Appl. No.: 14/499,315

(22) Filed: Sep. 29, 2014

Related U.S. Application Data
(60) Provisional application No. 62/022,780, filed on Jul. 10, 2014.

(51) Int. Cl. B60W 30/16

(52) U.S. Cl. CPC B60W 30/16

(57) ABSTRACT

A system for controlling the distance between a first moving vehicle and a second moving vehicle comprising: A distance sensor for measuring the distance between the first and second moving vehicles; A speed sensor for measuring the speed of the first moving vehicle; A speed control unit connected to the distance and speed sensors for determining a safe distance threshold as a function of the deceleration rate and speed; A notification unit connected to the speed control unit for notifying the driver of the first moving vehicle of any breach of the safe distance threshold; An authority alert unit connected to the speed control unit and to the traffic authorities via a wireless data network for alerting the traffic authorities of any violation of the safe distance threshold by the first moving vehicle, and a process for controlling the distance between a first moving vehicle and a second moving vehicle.

### FIELD OF THE INVENTION

The present invention relates to traffic control systems, and more particularly to a system and method for controlling the distance between moving vehicles in order to reduce risks of accidents.

### BACKGROUND OF THE INVENTION

Tailgating is a normal habit in the Gulf region, where the drivers do not keep a safe distance when they drive between their cars and the car in front. Not leaving enough distance between vehicles listed as key causes of car accidents in the UAE and the second leading violation.

There are many systems fitted in the premium and new cars to detect the surrounding cars using different types of sensors. Some of them alert the drivers that they exceed the maximum speed limit. However these systems are not adapted for preventing drivers from breaching their safe distance with other moving vehicles.

### SUMMARY OF THE INVENTION

To prevent rear collisions and reduce number of casualties, there is an urgent need to monitor the distance with other moving vehicles while driving and to fine drivers who breach the safe distance requirement. Also if an accident occurs, then the traffic authorities will be alerted on the location of the vehicle accident and on whether the cause of the accident was related to the breach of the safe distance requirement using telecommunication means such as a text message. The location of the vehicle would be detected using a GPS system installed in the car for example.

The system of the present invention is adapted to alert drivers that if they don't keep their safe distance, then a fine will be issued. If traffic authorities introduce a hefty fine then, drivers will think seriously to keep their safe distance which would result in reducing the probability of having an accident.

The system of the present invention is adapted to measure the distance between moving vehicles (e.g. between the vehicle in control and the vehicle in front) and compiling the measured distance based on the speed of the vehicle in control and the deceleration rate of the vehicle for determining the safe distance required. If the driver breaches the safe distance, then a warning is generated and displayed to the driver. This can be through a message appearing on an LCD screen located at the dashboard at the front of the car for example. A warning message such as “keep your safe distance” will alarm the driver to slow down. If the driver does not slow down within a predefined period of time (5 seconds for example), then a fine is issued by the traffic authorities. This can be done for example by sending an SMS via the GSM system to the traffic authorities with an indication of the plate number of the violating car.

As a first aspect of the invention, there is provided a system for controlling the safe distance between a first moving vehicle having a first driver and a second moving vehicle in the front or in the back of the first vehicle having a second driver, the system being adapted for installation at the first vehicle and comprising:
a distance sensor for measuring the distance between the first and second moving vehicles;
a speed sensor for measuring the speed of the first moving vehicle;
a speed control unit connected to the distance and speed sensors for determining a safe distance threshold as a function of the first vehicle speed and deceleration rate for determining if the safe distance threshold has been breached by comparing the measured distance between the vehicles to the determined safe distance threshold;
A notification unit connected to the speed control unit for notifying the first driver of any breach of the safe distance threshold; and
An authority alert unit connected to the speed control unit and to the traffic authorities via a wireless data network for alerting the traffic authorities of any violation of the safe distance threshold by the first moving vehicle.

Preferably, the speed sensor further measures the speed of the second moving vehicle, and wherein the safe distance threshold is determined based on the speeds of the first and second moving vehicles.

Preferably, the speed control unit comprises a timer, a distance sensor and a microprocessor, the speed of the second vehicle being determined based on mathematical calculations compiled as a function of the speed and deceleration rate of the first vehicle and the difference in distances between the first and second vehicles measured as a function of time by the distance sensor and the timer.

Preferably, the speed control unit is adapted to determine, in case of a breach of the safe distance threshold, whether the breach is caused by the first or the second vehicles or both of them based on the speed of the first vehicle, the speed of the second vehicle, the distance between the vehicles and on whether the second vehicle is in the front or in the back of the first vehicle.

Preferably, the system further comprises a weather condition detector connected to the speed control unit for compiling the weather conditions in addition to the speed of the first vehicle for the determination of the safe distance threshold.

Preferably, the weather condition detector comprises at least one of a fog detector, a rain detector and a temperature detector.

Preferably, the system further comprises a mechanic condition detector connected to the speed control unit for receiving data related to mechanic conditions of mechanic components of the first vehicle for being taken into account for the determination of the safe distance threshold, the mechanic components comprising the vehicle brakes and tires.

Preferably, the notification unit comprises a screen for notifying the first driver of any breach by displaying an alert message on the screen.

Preferably, the system further comprises a sound system for notifying the first driver of any breach by generating a vocal alert message.

Preferably, the notification unit further notifies the second driver at rear of any breach of the safe distance threshold.

Preferably, the notification unit comprises a screen visible to the second driver for notifying the second driver of any breach by displaying an alert message on the screen.

Preferably, the screen is adapted to be mounted at the rear windshields of the first vehicle.

Preferably, the system further comprises a choc detector for detecting the occurrence of an accident by the first vehicle. The choc detector being connected to the authority alert unit for reporting any occurrence of an accident to the traffic authorities.

Preferably, the choc detector is further connected to the speed control unit for providing an indication on whether the safe distance threshold has been breached by at least one of the vehicles within a predefined time before the occurrence of an accident.

Preferably, the speed control unit further determines and reports the vehicle among the first and second vehicles having breached the safe distance threshold.

Preferably, the system further comprises a camera adapted to capture images of the second vehicle in case of the occurrence of an accident between the first and second vehicles.

Preferably, the system further comprises a camera adapted to capture and store images of the second vehicle in case of breach of the safe distance threshold by the second vehicle.

Preferably, the images comprise the plate number of the second vehicle.

As a further aspect of the invention, there is provided a process of controlling the safe distance between a first moving vehicle having a first driver and a second moving vehicle in the front or in the back of the first vehicle having a second driver, the process comprising:
monitoring the speed of the first moving vehicle;
measuring the distance between the first moving vehicle and the second moving vehicle;
determining a safe distance threshold between the first and second moving vehicles based on the deceleration rate and speed of the first vehicle; and
determining if the safe distance is breached by comparing the measured distance to the determined safe distance threshold;
generating a notification message in case of breach of the safe distance threshold;
notifying the driver of the first moving vehicle of the breach.

Preferably, the process further comprises:
monitoring the weather conditions of the surrounding environment of the first vehicle; and
updating the deceleration rate of the first vehicle based on changes in the weather conditions.

Preferably, the process further comprises:
monitoring the mechanic conditions of the first vehicle; and
updating the deceleration rate of the first vehicle based on changes in the mechanic conditions.

Preferably, the process further comprises:
providing a grace period to the first moving vehicle for regulating its speed in order to increase the distance between the vehicles in compliance with the safe distance threshold;
alerting the traffic authorities of a violation of the safe distance threshold if the distance between the vehicles has not been regulated within the grace period.

Preferably, the process further comprises:
issuing a fine by the traffic authorities to the first or second moving vehicles as it is the case if an alert is received; and
notifying the driver of the issuance of the fine through a notification unit in communication between the traffic authorities and the first moving vehicle.

### BRIEF DESCRIPTION OF THE DRAWINGS

The invention will now be described with reference to the accompanying drawings, which illustrate a preferred embodiment of the present invention without restricting the scope of the invention's concept, and in which:

FIG. 1 is a block diagram illustrating a system for controlling a safe distance between moving vehicles in accordance with an embodiment of this invention;

FIG. 2 is a block diagram illustrating a notification unit in accordance with an embodiment of this invention;

FIG. 3 is a block diagram illustrating a weather condition detector in accordance with an embodiment of this invention;

FIG. 4 is a flow chart illustrating a process for controlling a safe distance between moving vehicles in accordance with an embodiment of this invention.

### DETAILED DESCRIPTION OF THE INVENTION

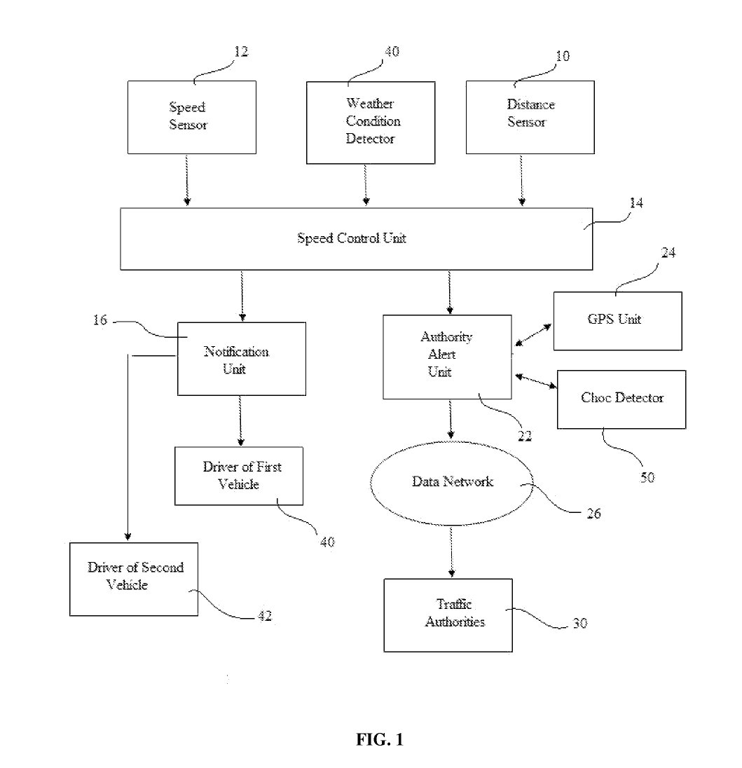

According to a first aspect of the present invention and as illustrated in FIG. 1, there is provided a system for controlling the distance between two moving vehicles, the system comprising a distance sensor 10 for measuring the distance between two moving vehicles, a first moving vehicle (the car that has the system fitted) and a second moving vehicle (the vehicle in front or the vehicle in the back), a speed sensor 12 for measuring the speed of the first moving vehicle, a speed control unit 14 connected to the distance sensor 10 and the speed sensor 12 for determining a safe distance threshold as a function of the measured speed and deceleration rate of the first vehicle (and preferably the second vehicle) and for comparing the safe distance threshold to the measured distance between the first and second vehicles, a notification unit 16 connected to the speed control unit 14 for notifying the driver 40 of the first moving vehicle (or the second moving vehicle as it is the case) of any breach of the safe distance threshold, and an authority alert unit 22 adapted to be connected to the speed control unit 14 and to the traffic authorities 30 for reporting to the traffic authorities 30 any breach of the safe distance threshold by the first moving vehicle (or the second moving vehicle as it is the case). The system also comprises a GPS unit 24 connected to the authority alert unit 22 for determining and providing the location of the first vehicle for reporting to the traffic authorities in case of accident and/or breach.

The distance sensor 10 can be any type of sensor capable of detecting distances between two moving objects, such as a radar sensor, ultrasonic sensor, infrared sensor, optical sensor, etc. The distance sensor 10 can comprise one or more sensors.

According to an embodiment of the invention, the speed sensor 12 has at least three sensors, a first speed sensor to detect the speed of the first vehicle, a second sensor to detect the speed of the vehicle in front and a third sensor to detect the speed of the vehicle in the back.

According to an embodiment of the invention, the speed sensor 12 comprises a timer, a distance sensor and a microprocessor/microcontroller, where the speed of the second vehicle is determined by conducting mathematical calculations based on the distances measured between the first and second vehicles as a function of time.

According to an embodiment of the invention, the distance sensor used by the speed sensor 12 is distance sensor 10 which is used to measure the distance between the first and second vehicles, and the microprocessor/microcontroller used is the same one used by the speed control unit 14.

According to an embodiment of the invention, the speed control unit 14 determines the safe distance threshold between the first vehicle and the second vehicle based on the speed of the first vehicle only.

According to an embodiment of the invention, the deceleration rate of the first vehicle is entered manually by a user (who can be the vehicle manufacturer for example).

According to an embodiment of the invention, the deceleration rate of the first vehicle is specified based on the type of the first vehicle and/or status of the mechanical components of the first vehicle.

According to an embodiment of the invention, the deceleration rate is an average deceleration rate preconfigured in said speed control unit 14 for all types of vehicles or for all vehicles for a same category.

According to an embodiment of the invention, the speed control unit 14 is connected to a database mapping vehicle types and/or characteristics to respective deceleration rates, where speed control unit 14 is adapted to determine the appropriate deceleration rate of the first vehicle based on the type and/or other vehicle characteristics of the first vehicle.

According to an embodiment of the invention, the speed control unit 14 is adapted to enable a user to enter vehicle characteristics allowing for determining the appropriate deceleration rate of the first vehicle.

According to an embodiment of the invention, the speed control unit 14 comprises a user interface for enabling the user to enter such information.

According to an embodiment of the invention, the speed control unit 14 determines the safe distance threshold between the first vehicle and the second vehicle based on the speed of the first vehicle and the speed of the second vehicle in addition to the deceleration rate of the first vehicle.

According to an embodiment of the invention, the speed control unit 14 determines the safe distance threshold between the first and second vehicles based on the deceleration rate of the first vehicle, the speed of the first vehicle and the maximum speed limit and/or average vehicle speeds in the traffic zone where the vehicles are located. The maximum speed limit and/or average vehicle speeds can be entered by the driver 40 manually in the system or can be accessed remotely from a remote database (not shown).

According to an embodiment of the invention, the speed control unit 14 determines any breach of the safe distance threshold by the first vehicle and/or the second vehicle.

According to an embodiment of the invention, the speed control unit 14 determines any breach of the maximum and/or minimum speed limit by the first vehicle and/or the second vehicle.

According to an embodiment of the invention, the speed control unit 14 determines which vehicle(s) among the first and second vehicles is/are the breaching vehicle(s).

According to an embodiment of the invention, the second vehicle is considered a breaching vehicle if it is in the back of the first vehicle and if the distance between the first and second vehicles is smaller than the safe distance threshold.

According to an embodiment of the invention, the second vehicle is considered a breaching vehicle if it is in the front of the first vehicle and if its speed is lower than the minimum speed allowed in the traffic zone where the vehicles are running and if the distance between the first and second vehicles is smaller than the safe distance threshold. In this case, the first vehicle can also be considered a breaching vehicle jointly with the second vehicle.

According to an embodiment of the invention, the system further comprises a weather condition detector 40.

According to an embodiment of the invention, the speed control unit 14 determines the safe distance threshold between the first and second vehicles taking into consideration the weather condition as detected by the weather condition detector 40.

According to an embodiment of the invention, the deceleration rate of the first vehicle is regularly updated based on the weather conditions detected by the weather condition detector 14. This update is preferably made in real time.

According to an embodiment of the invention, the system further comprises a mechanic condition detector 41 for detecting the conditions of certain mechanical components of the first vehicle such as the tires and the brakes. The mechanic condition detector 41 detects the consumption amount of the tires and the brakes which is taken into consideration for the determination of the safe distance threshold.

According to an embodiment of the invention, the deceleration rate used for determining the safe distance threshold is updated based on any change in the mechanic conditions of the mechanical components of the vehicle.

According to an embodiment of the invention, the mechanic condition detector 41 comprises suitable detectors and sensors adapted to be connected to the mechanic components in question.

According to an embodiment of the invention, the mechanic condition detector 41 is adapted to be connected receive the mechanic conditions from the first vehicle's computer system which is already adapted to detect these conditions.

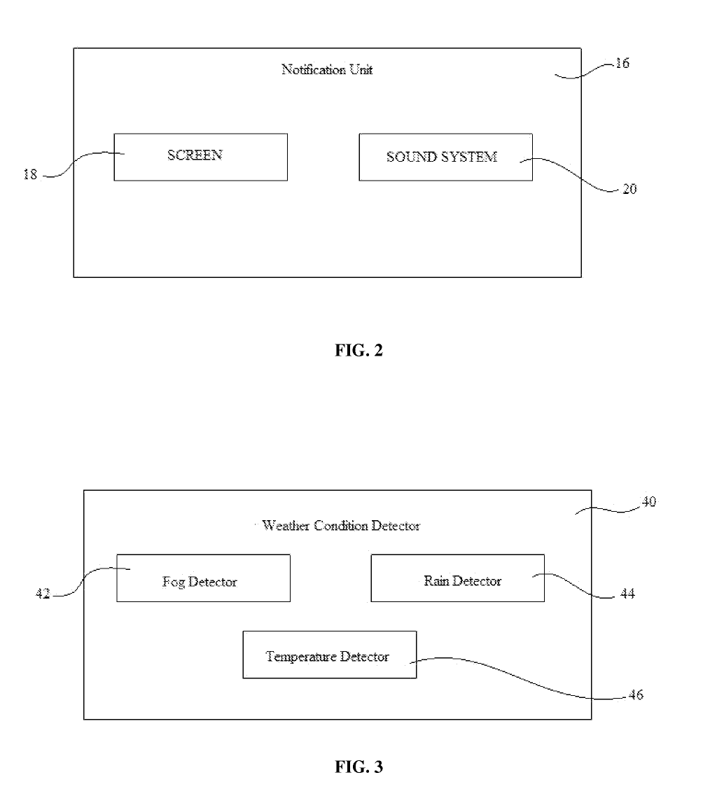

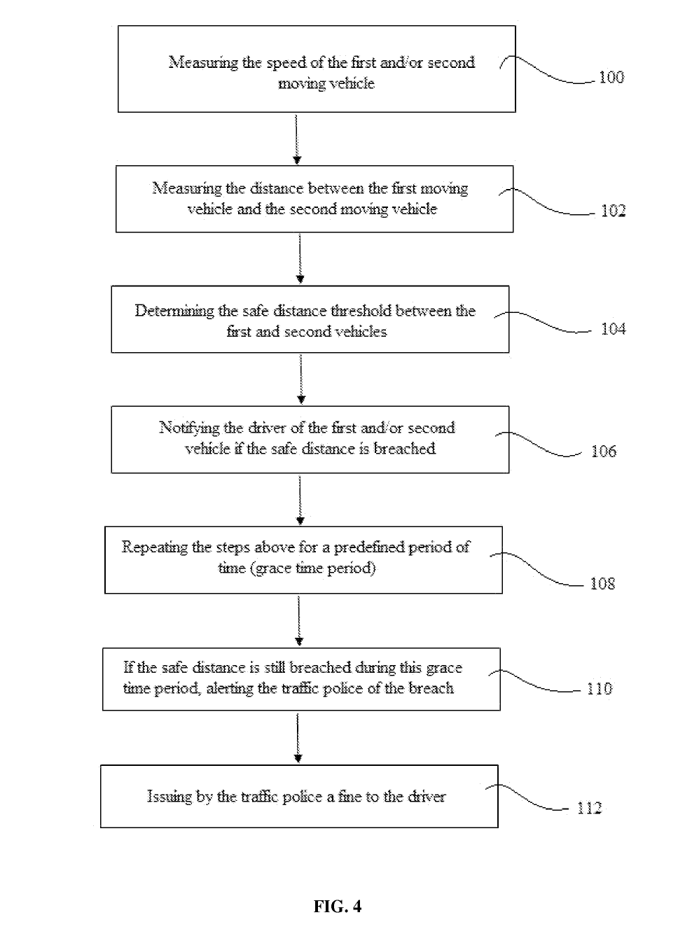

According to an embodiment of the invention and as illustrated in FIG. 3, the weather condition detector comprises a fog detector 42, a rain detector 44 and a temperature detector 46.

According to an embodiment of the invention, the notification unit 16 comprises a screen 18 adapted to generate and display an alert message to the driver of the first vehicle 40 (i.e. vehicle in control) for keeping a safe distance with the second vehicle (i.e. the vehicle in the front or in the back).

According to an embodiment of the invention, the notification unit 16 comprises a screen 18 adapted to generate and display an alert message to the driver of the second vehicle 42 (i.e. the vehicle in the back or in the front) for keeping a safe distance with the first vehicle (i.e. the vehicle in control).

According to an embodiment of the invention, the message displays in real time the safe distance threshold to the drivers 40 and 42.

According to an embodiment of the invention, in case of breach, the message displays an alert that the safe distance threshold has been breached.

According to an embodiment of the invention, the message displays which vehicle(s) among the first and second vehicles is/are the cause of the breach.

According to an embodiment of the invention, the screen 18 is adapted to be mounted in the first vehicle in such a manner to be visible to the driver of the second moving vehicle 42.

According to an embodiment of the invention, an alert message to the driver of the second vehicle 42 is generated if the vehicle in front is moving too slow (below the minimum speed limit) or if the vehicle in the back is moving too fast (above the maximum speed limit). In these cases, the drivers of these vehicles are alerted via screens 18 mounted on the first vehicle (i.e. vehicle in control) in such a manner to be visible to these drivers 42.

According to an embodiment of the invention, an alert message to the driver of the second vehicle 42 is generated even if the second vehicle is driving in compliance with the speed requirements but in case where the safe distance is being breached by the first vehicle. This is in order to give the opportunity to the second vehicle to take the precaution measures to avoid an accident with the first vehicle.

The screen 18 can be an LCD screen, but can be another type of screen.

According to an embodiment of the invention and as illustrated in FIG. 2, the notification unit 16 comprises a sound system 20 adapted to generate a vocal message to the driver of the first moving vehicle 40 for keeping a safe distance with the other vehicle. The sound system 20 comprises speakers.

According to an embodiment of the invention, the notification unit 16 comprises a sound system 20 adapted to generate a vocal message to the driver of the second moving vehicle 42 (i.e. vehicle in front or in the back) for keeping a safe distance with the first vehicle (i.e. vehicle in control).

According to an embodiment of the invention, the system further comprises a GPS unit 24 for determining the location of the first vehicle. The GPS unit is connected to the authority alert unit 22 for providing the location of the first vehicle when required by the authority alert unit 22.

According to an embodiment of the invention, the system also comprises an OBD-II adaptor.

According to an embodiment of the invention, the speed control unit 14, the notification unit 16 and the authority alert unit 22 comprise at least one processing unit or microcontroller.

According to an embodiment of the invention, the microprocessor and/or microcontroller is adapted determine the safe distance threshold based on preconfigured mathematical equations compiled using computer applications running on said microprocessor/microcontroller.

According to an embodiment of the invention, the second moving vehicle is a vehicle running in front of the first vehicle. In this case, the distance sensor 10 is located at the front side of the first moving vehicle.

According to an embodiment of the invention, the second moving vehicle is a vehicle running behind the first vehicle. In this case, the distance sensor 10 is located at the back side of the first moving vehicle.

According to an embodiment of the invention, the distance sensor 10 comprises two distance sensors, a first one located at the front side of the first moving vehicle and a second one located at the back side of the first moving vehicle.

According to an embodiment of the invention, the system further comprises a camera adapted to be mounted on the first vehicle for capturing images of the second vehicle including the plate number in case of breach of the safe distance by the second vehicle and/or occurrence of an accident.

According to an embodiment of the invention, the system is further adapted to detect the occurrence of an accident between the moving vehicles.

According to an embodiment of the invention, the authority alert unit 22 comprises a GSM modem, wherein the reporting of the breach is conducted by sending an SMS message to the traffic authorities. The communication between the notification unit 16 and the traffic authorities 30 can be conducted using any other medium such as satellite communication.

According to an embodiment of the invention, in case of breach, the message sent to the traffic authorities (violation message) comprises details of the breach, such as distance between vehicles during the breach, time when the breach has occurred, the location of the moving vehicles (as determined by the GPS), as well as an indication of the vehicle(s) and/or driver identity.

According to an embodiment of the invention, the system further comprises a choc detector 50 for detecting occurrence of an accident. Occurrence of an accident can however be detected in many other manners.

According to an embodiment of the invention, the speed control unit 14 is adapted to compile the distances between the vehicles within a certain window of time just before the accident and to determine whether the accident has occurred due to a breach of the safe distance.

According to an embodiment of the invention, in case of occurrence of an accident, the alert message would comprise details of the first moving vehicle, location of the accident, information allowing determining whether the accident has occurred because of any violation of the safe distance between the vehicles, images of the vehicles captured by the camera before and during the accident. This information may comprise distances between the vehicles for a certain period of time just before the accident (e.g. couple of seconds). The information would also comprise whether the breach of the safe distance is caused by the first or the second vehicle.

According to an embodiment of the invention, the alert message sent to the traffic authorities 30 comprises an indication of whether the accident has occurred due to non compliance with the safe distance requirement.

According to a second aspect of the present invention and as illustrated in FIG. 4, there is provided a process for controlling the safe distance between moving vehicles, the process comprising the steps of:
measuring the speed of the first moving vehicle and/or the second moving vehicle 100;
measuring the distance between the first moving vehicle and the second moving vehicle 102;
determining the safe distance threshold between the first and second vehicles 104;
notifying the driver of the first and/or second vehicle if the safe distance is breached 106;

According to an embodiment of the invention, the process further comprises monitoring the weather conditions of the surrounding environment of the first vehicle; and updating the deceleration rate of the first vehicle based on changes in the weather conditions 108.

According to an embodiment of the invention, the process further comprises monitoring the mechanic conditions of the first vehicle; and updating the deceleration rate of the first vehicle based on changes in the mechanic conditions 110.

According to an embodiment of the invention, the process further comprises repeating the above steps 100 to 110 for a predefined period of time (grace time period) 112, and if the safe distance is still breached during this grace time period, alerting the traffic authorities of the breach 114.

According to an embodiment of the invention, the steps above 102 to 110 (or at least a part thereof) are conducted continuously in real time whenever the first moving vehicle is in movement.

According to an embodiment of the invention, steps 102-110 are conducted only when the speed of the first moving vehicle as determined in step 100 is above a predefined speed threshold.

According to an embodiment of the invention, the process further comprises issuing by the traffic police a fine to driver of the first moving vehicle if an alert is received from the system 116.

Although the above description of the present invention has disclosed the features of the invention as applied to the preferred embodiment; additions, omissions and modifications applied to the details of the embodiment illustrated may be made by those skilled in the art without departing from the essential characteristic of the present invention.

Although the invention has been explained in relation to its preferred embodiment, it is to be understood that many other possible modifications and variations can be made without departing from the spirit and scope of the invention as herein described.

1. A system for controlling the safe distance between a first moving vehicle having a first driver and a second moving vehicle in the front or in the back of the first vehicle having a second driver, the system being adapted for installation at the first vehicle and comprising:
a distance sensor for measuring the distance between the first and second moving vehicles;
a speed sensor for measuring the speed of the first moving vehicle;
a speed control unit connected to the distance and speed sensors for determining a safe distance threshold as a function of the first vehicle deceleration rate and speed and for determining if the safe distance threshold has been breached by comparing the measured distance between the vehicles to the determined safe distance threshold;
A notification unit connected to the speed control unit for notifying the first driver of any breach of the safe distance threshold; and
An authority alert unit connected to the speed control unit and to the traffic authorities via a wireless data network for alerting the traffic authorities of any violation of the safe distance threshold by the first moving vehicle.

2. The system as claimed in claim 1 wherein the speed sensor further measures the speed of the second moving vehicle, and wherein the safe distance threshold is determined further taking into account the speed of the second moving vehicle.

3. The system as claimed in claim 2 wherein the speed sensor comprises a timer, a distance sensor and a microprocessor, the speed of the second vehicle being determined based on mathematical calculations compiled as a function of the speed of the first vehicle and the difference in distances between the first and second vehicles measured as a function of time.

4. The system as claimed in claim 2 wherein the speed control unit is adapted to determine, in case of a breach of the safe distance threshold, whether the breach is caused by the first or the second vehicles or both of them based on the speed of the first vehicle, the speed of the second vehicle, the distance between the vehicles and on whether the second vehicle is in the front or in the back of the first vehicle.

5. The system as claimed in claim 1 further comprising a weather condition detector connected to the speed control unit for receiving data related to weather conditions in the external environment of the first vehicle for being taken into account for the determination of the safe distance threshold.

6. The system as claimed in claim 5 wherein the weather condition detector comprises at least one of a fog detector, a rain detector and a temperature detector respectively detecting and receiving data related to fog presence and density, rain presence and density, and the temperature rate in the environment of the first vehicle.

7. The system as claimed in claim 1 further comprising a mechanic condition detector connected to the speed control unit for receiving data related to mechanic conditions of mechanic components of the first vehicle for being taken into account for the determination of the safe distance threshold, the mechanic components comprising the vehicle brakes and tires.

8. The system as claimed in claim 1 wherein the notification unit comprises a screen for notifying the first driver of any breach by displaying an alert message on the screen.

9. The system as claimed in claim 8 further comprising a sound system for notifying the first driver of any breach by generating a vocal alert message.

10. The system as claimed in claim 9 wherein the notification unit further notifies the second driver of any breach of the safe distance threshold using a screen visible to the second driver and adapted to be mounted at the first vehicle.

11. The system as claimed in claim 1 further comprising a choc detector for detecting the occurrence of an accident by the first vehicle, the choc detector being connected to the authority alert unit for reporting any occurrence of an accident to the traffic authorities.

12. The system as claimed in claim 11 wherein the choc detector is further connected to the speed control unit for providing an indication on whether the safe distance threshold has been breached by at least one of the vehicles within a predefined time before the occurrence of the accident.

13. The system as claimed in claim 12, the speed control unit further determining and reporting the identity of the vehicle among the first and second vehicles having breached the safe distance threshold.

14. The system as claimed in claim 13 further comprising a camera adapted to capture images of the second vehicle in case of the occurrence of an accident between said first and second vehicles.

15. The system as claimed in claim 1 further comprising a camera adapted to capture and store images of the second vehicle in case of breach of the safe distance threshold by said second vehicle, said images comprising the plate number of the second vehicle.

16. A process of controlling the safe distance between a first moving vehicle having a first driver and a second moving vehicle in the front or in the back of the first vehicle having a second driver, the method comprising:
monitoring the speed of the first moving vehicle;
measuring the distance between the first moving vehicle and the second moving vehicle;
determining a safe distance threshold between the first and second moving vehicles based on deceleration rate and speed of the first vehicle; and
determining if the safe distance is breached by comparing the measured distance to the determined safe distance threshold;
generating an notification message in case of breach of the safe distance threshold;
notifying the driver of the first moving vehicle of the breach.

17. The process of claim 16 further comprising:
monitoring the weather conditions of the surrounding environment of the first vehicle; and
updating the deceleration rate of the first vehicle based on changes in the weather conditions.

18. The process of claim 17 further comprising:
monitoring the mechanic conditions of the first vehicle; and
updating the deceleration rate of the first vehicle based on changes in the mechanic conditions.

19. The process of claim 18 further comprising:
providing a grace period to the first moving vehicle for regulating its speed in order to increase the distance between the vehicles in compliance with the safe distance threshold;
alerting the traffic authorities of a violation of the safe distance threshold if the distance between the vehicles has not been regulated within the grace period.

20. The process of claim 19 further comprising:
issuing a fine by the traffic authorities to the first or second moving vehicles as it is the case if an alert is received; and
notifying the driver of the issuance of the fine through a notification unit in communication between the traffic authorities and the first moving vehicle.
